(19) United States
(12) Patent Application Publication
(10) Pub. No.: US 2024/0367715 A1
(43) Pub. Date: Nov. 7, 2024

(54) PARALLEL PARKING SYSTEMS, VEHICLES EQUIPPED THEREWITH, AND METHODS OF USE

(71) Applicant: Purdue Research Foundation, West Lafayette, IN (US)

(72) Inventors: Collin Robert Allen, Hobart, IN (US); Anne Marie Cunningham, New Lenox, IL (US); Dejan Kloth, Merrillville, IN (US)

(21) Appl. No.: 18/652,455

(22) Filed: May 1, 2024

Related U.S. Application Data
(60) Provisional application No. 63/499,404, filed on May 1, 2023.

(51) Int. Cl. B62D 6/00; B62D 1/02; B62D 5/04; B62D 5/22

(52) U.S. Cl. CPC B62D 6/002; B62D 1/02; B62D 5/0442; B62D 5/22

(57) ABSTRACT

Parallel parking systems, vehicles equipped therewith, and methods of parallel parking a vehicle. Such a vehicle includes front and rear ends disposed on opposite ends of a longitudinal axis of the vehicle. At least one front wheel is disposed near the front end of the vehicle, at least one rear wheel is disposed near the rear end of the vehicle, a first steering mechanism is operatively coupled to the front wheel to change a turn angle of the front wheel, and a second steering mechanism operatively is coupled to the rear wheel to change a turn angle of the rear wheel independently of the front wheel.

### CROSS-REFERENCE TO RELATED APPLICATIONS

This application claims the benefit of U.S. Provisional Application No. 63/499,404 filed May 1, 2023, the contents of which are incorporated herein by reference.

### BACKGROUND OF THE INVENTION

The invention generally relates to parallel parking systems, vehicles equipped therewith, and methods of parallel parking a vehicle.

Parallel parking is the bane of many drivers, especially with those who are often dealing with busy city traffic. A person struggling with parallel parking can cause backups on busy roads, as well as small accidents from bumping into surrounding cars while trying to pull in. This has been mitigated through computer assisted auto-parking features that are commercially available. However, there is still the issue of time consumed to partially drive past the intended parking space, potentially causing a block or collision with a vehicle behind the vehicle being parked.

Throughout their evolution, automobiles have been equipped with various systems designed to simplify this inconvenient matter. One such system utilized an additional wheel disposed at one end of a vehicle and adapted to lift and then turn the vehicle after it had moved into a parking space. This design has not become popular, however, since it requires a hydraulic system to lift the car through the additional wheel. The additional wheel and hydraulic system add more weight and occupy a majority of the trunk space.

Another proposed system involves all four wheels of a vehicle being adapted to turn at an angle approaching ninety degrees. An in-wheel motor is installed on each wheel to rotate each wheel, allowing the vehicle to move in a perpendicular or nearly perpendicular direction to its longitudinal axis, allowing a straight and smooth transition into a space between two parked cars or other obstacles. A shortcoming with this system, however, is that each of the wheels must be powered separately to enable each wheel to turn without constraints from its axle. Though efficient for certain applications, such as a cargo or transportation vehicle that travels in a small area, such an approach is not practical for everyday use with vehicles intended to travel great distances.

From this, it can be appreciated that it would be desirable to have a parallel parking system that addresses shortcomings such as those noted above for previous approaches.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, parallel parking systems, vehicles equipped therewith, and methods of parallel parking a vehicle.

According to a nonlimiting aspect, a vehicle having a parallel parking system includes a front end and a rear end disposed on opposite ends of a longitudinal axis of the vehicle, wherein the longitudinal axis is aligned with forward and rearward directions of travel of the vehicle. The vehicle further includes a front wheel disposed closer to the front end of the vehicle than to the rear end of the vehicle, a rear wheel disposed closer to the rear end of the vehicle than to the front end of the vehicle, a first steering mechanism operatively coupled to the front wheel to change a turn angle of the front wheel; and a second steering mechanism operatively coupled to the rear wheel to change a turn angle of the rear wheel independently of the front wheel.

According to another nonlimiting aspect, a method is provided for parallel parking a vehicle that has a front wheel disposed closer to a front end of the vehicle than to a rear end of the vehicle, and a rear wheel disposed closer to the rear end of the vehicle than to the front end of the vehicle. The front end and the rear end are disposed on opposite ends of a longitudinal axis of the vehicle that is aligned with forward and rearward directions of travel of the vehicle. The vehicle further includes a first steering mechanism being operatively coupled to the front wheel to change a turn angle of the front wheel, and a second steering mechanism operatively coupled to the rear wheel to change a turn angle of the rear wheel independently of the front wheel. The method includes moving the front end of the vehicle forward into a parking space at a diagonal angle to a longitudinal axis of the parking space to guide the front end of the vehicle diagonally toward a front end of the parking space at an angle. Before reaching the front end of the parking space, the rear wheel is turned with the second steering mechanism. With the rear wheel turned, the front end of the vehicle continues to move toward the front end of the parking space and thereby move the rear end of the vehicle laterally into a rear end of the parking space until the longitudinal axis of the vehicle is substantially parallel with the longitudinal axis of the parking space.

Technical aspects of systems, methods, and vehicles having features as described above preferably include the capability of reducing traffic disruptions, improving safety, and/or reducing repositioning associated with parallel parking.

These and other aspects, arrangements, features, and/or technical effects will become apparent upon detailed inspection of the figures and the following description.

### BRIEF DESCRIPTION OF THE DRAWINGS

FIG. 1 is schematic top view of a vehicle with a parallel parking system according to a nonlimiting example of the invention.

FIG. 2 is a schematic view of a first embodiment of a rear wheel steering system of the parallel parking system according to certain nonlimiting aspects of the invention.

FIG. 3 is a schematic view of a second embodiment of a rear wheel steering system of the parallel parking system according to certain nonlimiting aspects of the invention.

FIGS. 4A through 4D are diagrams representing different turn positions of front wheels and rear wheels attainable with front and rear wheel steering systems of the parallel parking system according to certain nonlimiting aspects of the invention.

FIG. 5 illustrates a possible use scenario of the parallel parking system according to certain nonlimiting aspects of the invention.

### DETAILED DESCRIPTION OF THE INVENTION

The intended purpose of the following detailed description of the invention and the phraseology and terminology employed therein is to describe what is shown in the drawings, which relate to one or more nonlimiting embodiments of the invention, and to describe certain but not all aspects of the embodiment(s) to which the drawings relate. The following detailed description also identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

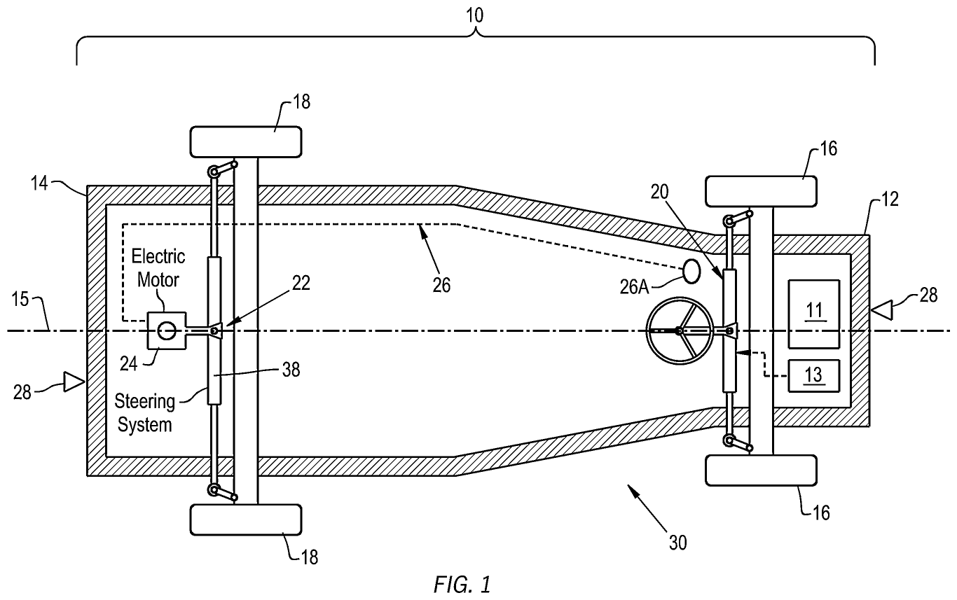

FIG. 1 represents a nonlimiting embodiment of a vehicle 30 with a parallel parking system 10 according to certain aspects of the invention. To facilitate the description provided below of the vehicle 30 and system 10, relative terms, including but not limited to, “proximal,” “distal,” “anterior,” “posterior,” “vertical,” “horizontal,” “lateral,” “front,” “rear,” “side,” “forward,” “rearward,” “top,” “bottom,” “upper,” “lower,” “above,” “below,” “right,” “left,” etc., (and various forms thereof) may be used in reference to the orientation of a parallel parking system 10 during its use and/or as represented in the drawings. All such relative terms are useful to describe the illustrated embodiment(s) but should not be otherwise interpreted as limiting the scope of the invention.

Goals of parallel parking systems 10 disclosed herein preferably include the ability to be incorporated into a vehicle 30 and enable the vehicle 30 to parallel park by pulling a front end 12 of the vehicle 30 diagonally into a parking space in which the driver of the vehicle 30 wishes to park, and then steering rear wheels (tires) of the vehicle 30 to allow a rear end 14 of the vehicle 30 to move in a lateral direction, i.e., transverse to a longitudinal axis 15 of the vehicle 30, so as to laterally “swing” the rear end 14 of the vehicle 30 into the parking space, allowing the driver to park the vehicle 30 with efficiency and safety, and potentially reducing traffic disruptions and/or accidents on busy city streets.

The vehicle 30 depicted in FIG. 1 is representative of an automobile, such as a passenger vehicle (e.g., car, truck, etc.) or a commercial vehicle (e.g., tractor, etc.), as nonlimiting examples. The vehicle 30 includes the aforementioned front and rear ends 12 and 14 disposed on opposite ends of the longitudinal axis 15 of the vehicle 30, i.e., the axis of the vehicle 30 that is aligned with forward and rearward directions of travel of the vehicle 30. The vehicle 30 is equipped with at least one front wheel 16 (represented by two front wheels 16 in the drawings) and at least one rear wheel 18 (represented by two rear wheels 18 in the drawings). The front and rear wheels 16 and 18 are designated as such on the basis that the front wheels 16 are disposed closer to the front end 12 of the vehicle 30 than to the rear end 14 of the vehicle 30, and the rear wheels 18 are disposed closer to the rear end 14 of the vehicle 30 than to the front end 12 of the vehicle 30. The vehicle 30 includes a self-contained primary power source 11, which may be any system capable of delivering rotational motion to any one or more of the wheels 16 and 18, nonlimiting examples of which include internal combustion engines, electric motors, and hybrids thereof.

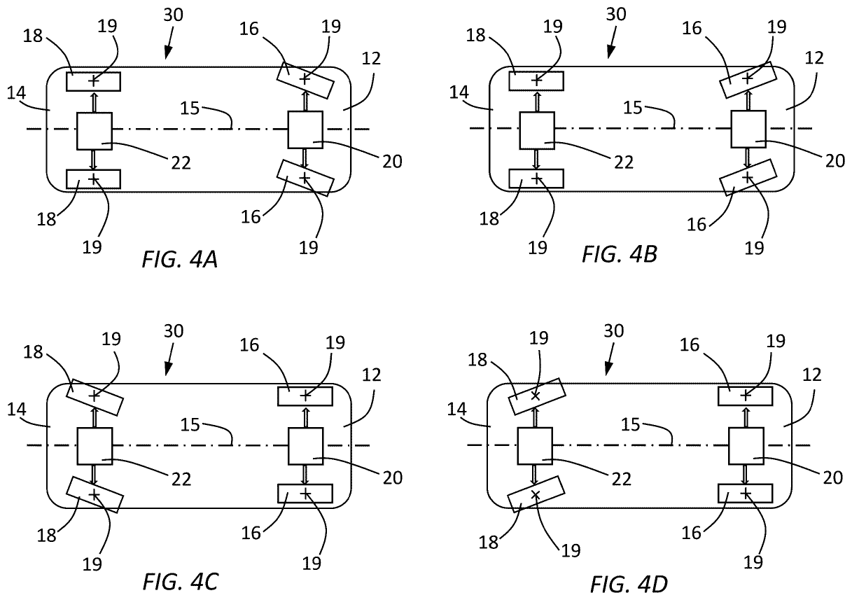

Each of the front and rear wheels 16 and 18 is adapted to rotate on a respective axis thereof that approximately lies within a horizontal plane of the vehicle 30. A first steering mechanism, referred to herein as a front wheel steering system 20, is operatively coupled to the front wheel(s) 16 to turn the front wheel(s) 16, and a second steering mechanism, referred to herein as a rear wheel steering system 22, is operatively coupled to the rear wheel(s) 18 to turn the rear wheel(s) 18. To distinguish the rotation and turning capabilities of the wheels 16 and 18, as used herein the term “rotation” (and related forms thereof) refers to the rotation of the wheels 16 and 18 on their respective “horizontal” axes, and the term “turn” (and related forms thereof) is used to refer to a pivoting capability of a wheel 16 and/or 18 on a respective “turn” axis 19 thereof (FIGS. 4A through 4D) that each approximately lies in a vertical plane oriented approximately perpendicular to the horizontal plane of the vehicle 30.

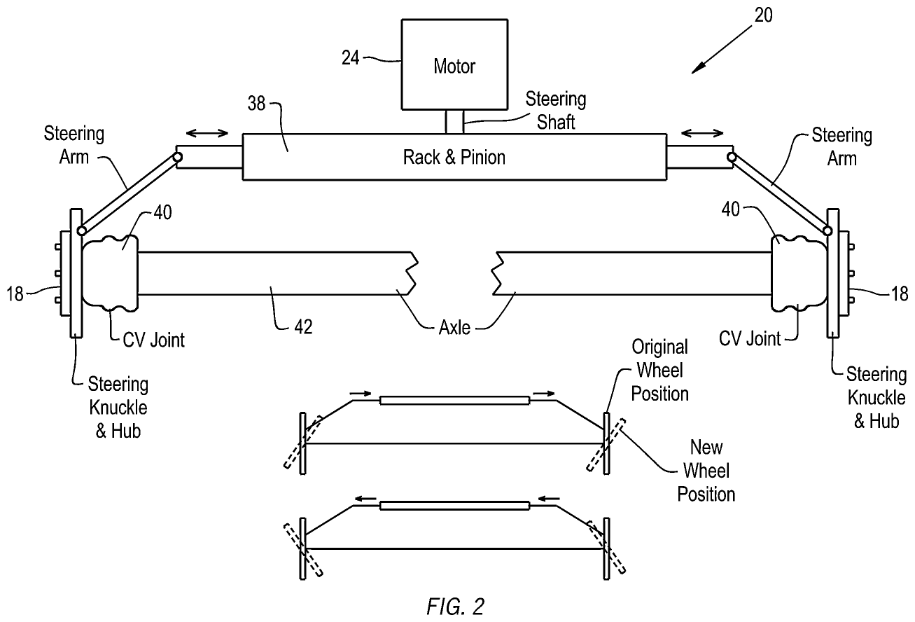

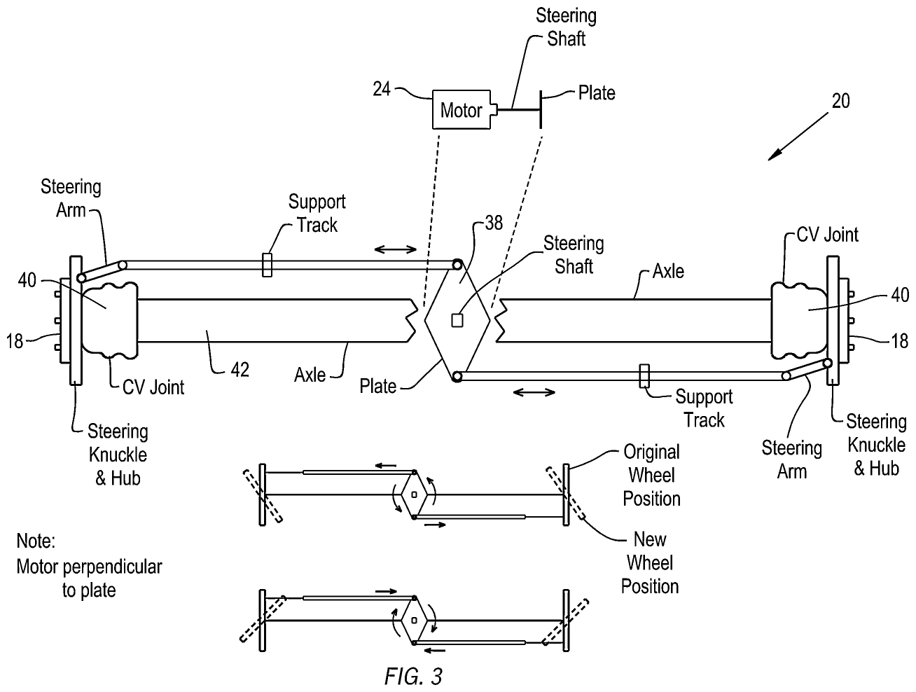

The front and rear wheel steering systems 20 and 22 operate independently of each other, such that the front wheels 16 are capable of being turned independently of the rear wheels 18. The rear wheel steering system 22 may take any form suitable for turning the rear wheels 18. In an example represented in FIG. 2, the rear wheel steering system 22 is a rack and pinion steering assembly. In another example represented in FIG. 3, the rear wheel steering system 22 is a plate steering assembly. However, the rear wheel steering system 22 may be implemented with different kinds of steering assemblies, and need not be limited to the two example steering assemblies shown herein. If the vehicle 30 has approximately the same amount of open space in front of or behind both the rear wheels 18, then a rack and pinion steering system may be better suited (FIG. 2), whereas a plate steering system (FIG. 3) may be better suited if the amount of open space in front of one rear wheel 18 is approximately the same as the parking space available behind the other rear wheel 18. This is because the two steering systems work opposite each other in terms of the process with which the wheels turn in relation to the rotation of the primary power source 11.

In examples represented in FIGS. 4A through 4D, the front wheel steering system 20 is configured to turn each of the front wheels 16 in parallel with each other (FIGS. 4A and 4B), and the rear wheel steering system 22 is configured to turn each of the rear wheels 18 in parallel with each other (FIGS. 4C and 4D). For example, in FIGS. 4A and 4B the front wheel steering system 20 is represented as simultaneously turning both front wheels 16 clockwise (to the “right”) in FIG. 4A and counterclockwise (to the “left”) in FIG. 4B about their turn axes 19 and relative to the longitudinal axis 15 of the vehicle 30, and in FIGS. 4C and 4D the rear wheel steering system 22 is represented as simultaneously turning both rear wheels 18 clockwise (to the “right”) in FIG. 4C and counterclockwise (to the “left”) in FIG. 4D about their turn axes 19 and relative to the longitudinal axis 15 of the vehicle 30. The wheels 16 and 18 are preferably capable of being turned through a wide range of “turn” angles relative to the longitudinal axis 15, as a nonlimiting example, up to about 45 degrees from the longitudinal axis 15. It should be appreciated from FIGS. 4A through 4D that the turn angles of the wheels 16 and 18 determine turning radii (including the minimum turning radius) of the vehicle 30. Preferably, the rear wheel steering system 22 is configured to turn the rear wheels 18 to any desired turn angle within its complete range of turn angles.

In some arrangements, driveshaft couplings 40, such as constant velocity (CV) joints or universal (U) joints, couple the rear wheels 18 to opposite ends of a rear axle 42. Other components of the rear wheel steering system 22, such as steering arms, steering knuckles and hubs, steering shafts, support tracks, plates, steering shafts, etc., are well understood in the art and are not described in any detail here.

The rear wheel steering system 22 is represented in FIG. 1 as powered by a second power source 24 to turn the rear wheels 18 left or right in response to control commands received from the driver (not shown) and/or an automatic parking system 13, such as a steering program executed on one or more processors. The power source 24 is preferably an electric motor, for example a DC motor powered by an electrical system of the vehicle 30. However, other types of power sources, such as hydraulic or steam motors, could be used. In this example, the power source 24 may be oriented in any suitable orientation on the vehicle 30.

Preferably, the turn angle to which the rear wheels 18 are turned for any particular maneuver is decided and controlled by the vehicle operator, whether a human driver or an auto-parking artificial intelligence (AI), depending on factors including, for example, the size of a parking space in which the vehicle 30 is to be parked, the size of the vehicle 30, and minimum turning radius of the vehicle 30. To aid in choosing an optimal turn angle, a steering control mechanism 26 may be provided through which the driver is able to control the turn angle of the rear wheels 18. The steering control mechanism 26 may include a steering control input device 26A through which control commands may be manually input by a driver, and a locking mechanism 38 to keep the rear wheels 18 from turning while the vehicle 30 is in motion. The steering control input device 26A is represented in FIG. 1 as disposed in or near the driver cockpit so that the driver can readily operate the steering mechanism 26 while sitting in the driver's seat. The steering control input device 26A may take any suitable form of human-machine interface, such as a knob, wheel, lever, or computer-controlled touch screen.

As represented in FIG. 1, an automatic parking system 13 may be integrated with the parallel parking system 10. Current conventional automatic parallel parking systems still require the driver to pull out in front of an intended parking space. The time required to activate an automatic parking system can be such that a second vehicle approaching the rear of the vehicle being parked can become an issue. In contrast, if incorporated into the parallel parking system 10 described herein, an automatic parking system 13 can be initiated while the vehicle 30 is still behind the intended parking space, and enables an automated controller of the automatic parking system 13 (optionally using artificial intelligence (AI)) to turn both the front and rear wheels 16 and 18 at the same time allows the automatic parking system 13 to park in more difficult situations than current automatic parallel parking systems. The implementation of such an automatic parking system 13 preferably includes one or more sensors 28, such as video cameras and/or proximity sensors, located at suitable locations around the vehicle 30 to be able to sense the proximity of adjacent automobiles, curbs, and/or other objects. The automatic parking system 13 may include an artificial intelligence software engine and/or machine learning software engine program executed by the processor(s) configured to control steering of the rear wheels 18 and/or the front wheels 16 in response to objects sensed by the sensors 28 in the immediate vicinity of the vehicle 30. In one nonlimiting example, the sensors 28 on the outside of the vehicle 30 may be linked to a display on the vehicle dashboard that can be referenced during the parallel parking process. The sensors 28 may turn on and provide real time information in the driver's cockpit that can allow the driver to better avoid adjacent vehicles and/or other obstacles by warning the driver of potential collision risks. Preferably, such a warning is provided with sufficient time to give the driver ample time to stop and/or maneuver the vehicle 30 in a manner to avoid the conflict.

In some optional arrangements, a mechanism may be provided that will change the turn angle of the rear wheels 18 in increments, establishing an optimized position to begin the parking process. The steering control input device 26A in the driver's cockpit that is linked to the power source 24 may be provided for manual use by the driver. This may be implemented with a standard if/else computer program code that allows the operator to turn the rear wheels 18 from the front of the vehicle 30. This steering mechanism may include a safety mechanism that stops the operator from turning the rear wheels 18 by accident, or while the vehicle 30 is in motion, for example with a spring locked knob or a mechanical lock that releases once the vehicle 30 is in park.

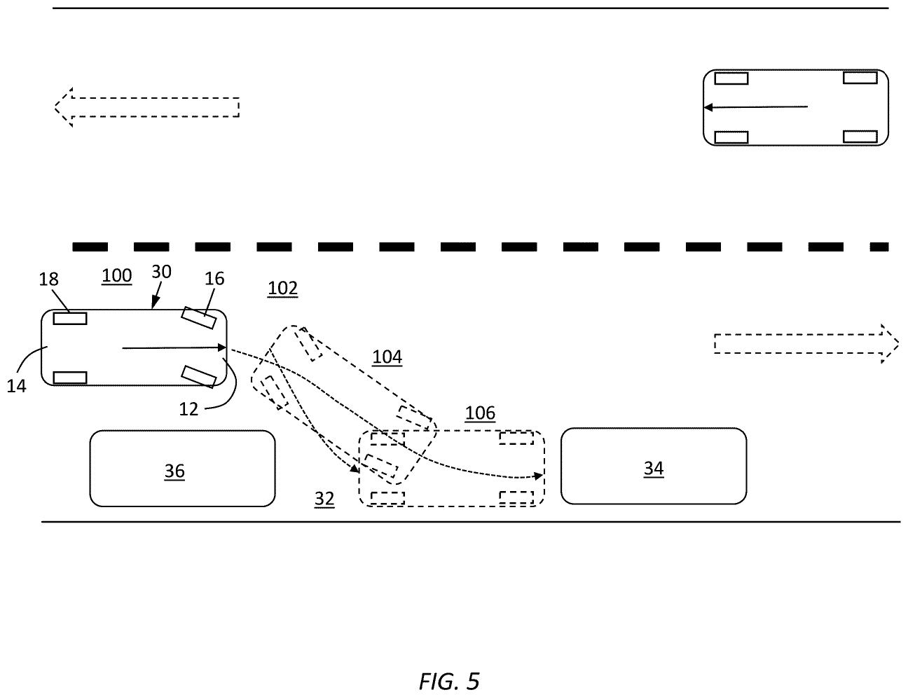

FIG. 5 schematically represents a nonlimiting example of a method of parallel parking the vehicle 30 equipped with the parallel parking system 10 implemented therein. At a first step 100, the vehicle 30 approaches an available (open) parking space 32 on the right side of a road between a forward parked car 34 and a rearward parked car 36 while the vehicle 30 is moving in the forward direction of travel, i.e., parallel to its longitudinal axis 15. At this stage, the rear wheels 18 are aligned parallel with the longitudinal axis 15 of the vehicle 30 in the forward direction of travel. The rear wheel steering system 22 may be locked into the longitudinal alignment at this stage to prevent accidental or unwanted turning of the rear wheels 18 before needed or desired. As the vehicle 30 approaches the parking space 32 and before it moves past the parking space, at a second step 102, the front end 12 of the vehicle 30 is moved forward into the parking space 32 at a diagonal angle to a longitudinal axis of the parking space 32 (parallel to the vehicle's forward direction of travel) to guide the front end 12 of the vehicle 30 diagonally right and forward toward a front end of the parking space 32 at an angle. This is accomplished, for example, by turning the front wheels 16 to the right with the front wheel steering system 20. Before reaching the front end of the parking space 32, at step 104 the rear wheels 18 are turned to the right with the rear wheel steering system 22. This may be accomplished, for example, by engaging the power source 24 using the steering control input device 26A to operate the rear wheel steering system 22 independently of the front wheel steering system 20. If the rear wheel steering system 22 had been previously locked in the longitudinal alignment, the lock would first be unlocked to allow the rear wheels 18 to turn. With the rear wheels 18 thus turned, the vehicle 30 continues to move toward the front end of the parking space 32, thereby swinging the rear end 14 of the vehicle 30 laterally to the right into a rear end of the parking space 32. This continues until the longitudinal axis 15 of the vehicle 30 is substantially parallel with the longitudinal axis of the parking space 32. Thereafter at step 106, the rear wheels 18 may be turned back to the longitudinal alignment, for example by again engaging the power source 24 using the steering control input device 26A and optionally re-locked into the longitudinal alignment.

From this example, it can be seen that the parallel parking system 10 essentially works as the reversed process of “normal” parallel parking. That is, instead of backing into a parking space 32 and turning the front wheels 16 before backing into the parking space 32, the driver pulls forward into the parking space 32, then turns the rear wheels 18, and thereafter finally pull forward again to straighten the vehicle 30. This method of parallel parking enables the driver to pull into the parking space 32 immediately instead of driving past it, and also helps the driver avoid the curb, reducing the number of attempts needed to park the vehicle 30. Thus, the parallel parking system 10 may also shorten the time it normally takes a driver to park, since one of the main reasons a driver needs to retry a parking attempt is due to encountering a curb along the desired parking space.

The parallel parking system 10 is preferably capable of providing a safer, shorter, and simpler transition into parallel parking spaces and reducing traffic and accidents in comparison to the efficiency of pre-existing auto-parking technology Further benefits of the parallel parking system 10 include the negation of needing to pull past a parking space in which the driver wishes to park and then backing into the parking space, and the avoidance of needing extra time to perform multiple attempts to parallel park. Not needing to pull past the parking space is beneficial because, if the driver is not backing into a parking space, then the driver does not need to position the vehicle 30 with the rear end 14 closest to the parking space. Instead, the driver simply positions the vehicle 30 with the front end 12 closest to the parking space, i.e., before driving past it. This may also help avoid the loss of a parking space due to other vehicles following too close to the vehicle 30 and blocking the vehicle 30 from parallel parking.

There may be multiple possible benefits of being able to avoid making repeated attempts. For example, it may be much easier to avoid a curb when parallel parking using the parallel parking system 10 because the front wheels 16 can still be used while moving forward, so the driver can turn the front wheels 16 parallel to the curb and thus avoid it. In comparison, normal parallel parking (in reverse) does not afford the driver this same benefit, because the driver cannot turn the rear wheels while backing up. Another cause of restarting a parking attempt is not being close enough to the curb, which can be an issue if the vehicle is laterally too far from the desired parking space. The parallel parking system 10 also helps to remedy this issue by allowing the driver to pull the vehicle 30 into a parking space at a steeper angle than could normally be performed with conventional parallel parking techniques. The steeper angle allows the driver to more easily judge how far the vehicle 30 needs to go into the parking space, as once again, the front wheels 16 can be turned to get an acceptable parking attempt completed.

As previously noted above, though the foregoing detailed description describes certain aspects of one or more particular embodiments of the invention, alternatives could be adopted by one skilled in the art. For example, the parallel parking system 10 and its components could differ in appearance and construction from the embodiments described herein and shown in the drawings, functions of certain components of the parallel parking system 10 could be performed by components of different construction but capable of a similar (though not necessarily equivalent) function, and various materials could be used in the fabrication of the parallel parking system 10 and/or their components. As such, and again as was previously noted, it should be understood that the invention is not necessarily limited to any particular embodiment described herein or illustrated in the drawings.

1. A vehicle with a parallel parking system, the vehicle comprising:
a front end and a rear end being disposed on opposite ends of a longitudinal axis of the vehicle, the longitudinal axis being aligned with forward and rearward directions of travel of the vehicle;
a front wheel disposed closer to the front end of the vehicle than to the rear end of the vehicle;
a rear wheel disposed closer to the rear end of the vehicle than to the front end of the vehicle;
a first steering mechanism operatively coupled to the front wheel to change a turn angle of the front wheel; and
a second steering mechanism operatively coupled to the rear wheel to change a turn angle of the rear wheel independently of the front wheel.

2. The vehicle of claim 1, wherein the second steering mechanism comprises a power source configured to drive turning of the rear wheel.

3. The vehicle of claim 2, wherein the power source is at least one of an electric motor and a hydraulic motor.

4. The vehicle of claim 1, wherein the second steering mechanism comprises a rack and pinion steering mechanism.

5. The vehicle of claim 1, wherein the second steering mechanism comprises a plate steering mechanism.

6. The vehicle of claim 1, further comprising a steering controller in the vehicle for manually controlling the second steering mechanism.

7. The vehicle of claim 6, wherein the controller comprises a manual selector that can be adjusted by a driver of the vehicle to control turning of the rear wheel.

8. The vehicle of claim 6, wherein the controller comprises an automated control system comprising a sensor for sensing positions of the vehicle relative to surrounding objects and at least one computer processor operatively coupled to the sensor to receive data therefrom, wherein the at least one computer processor is configured to run a program to automatically control steering of the rear wheel based at least partly on data from the sensor.

9. The vehicle of claim 8, wherein the program comprises an artificial intelligence engine.

10. The vehicle of claim 1, wherein the vehicle comprises two rear wheels.

11. The vehicle of claim 1, wherein the vehicle comprises two front wheels.

12. The vehicle of claim 1, wherein the vehicle comprises a primary power source for causing rotation of at least one of the front wheel and the rear wheel.

13. The vehicle of claim 12, wherein the primary power source comprises at least one of an internal combustion engine, an electric motor, and a hybrid thereof.

14. The vehicle of claim 12, wherein the vehicle is a passenger vehicle.

15. The vehicle of claim 1, further comprising a lock mechanism that locks the rear wheel parallel with the longitudinal axis, wherein the lock mechanism can be selectively unlocked to allow turning of the rear wheel and selectively locked to prevent turning of the rear wheel.

16. A method of parallel parking a vehicle having a front wheel disposed closer to a front end of the vehicle than to a rear end of the vehicle, a rear wheel disposed closer to the rear end of the vehicle than to the front end of the vehicle, the front end and the rear end being disposed on opposite ends of a longitudinal axis of the vehicle that is aligned with forward and rearward directions of travel of the vehicle, a first steering mechanism being operatively coupled to the front wheel to change a turn angle of the front wheel, and a second steering mechanism operatively coupled to the rear wheel to change a turn angle of the rear wheel independently of the front wheel, the method comprising:
moving the front end of the vehicle forward into a parking space at a diagonal angle to a longitudinal axis of the parking space to guide the front end of the vehicle diagonally toward a front end of the parking space at an angle;
before reaching the front end of the parking space, turning the rear wheel with the second steering mechanism; and
with the rear wheel turned, continuing to move the front end of the vehicle toward the front end of the parking space and thereby moving the rear end of the vehicle laterally into a rear end of the parking space until the longitudinal axis of the vehicle is substantially parallel with the longitudinal axis of the parking space.

17. The method of claim 16, wherein the step of turning the rear wheel comprises engaging a power source operatively coupled with the second steering mechanism to operate the second steering mechanism independently of the first steering mechanism.

18. The method of claim 16, wherein the second steering mechanism comprises a rack and pinion steering mechanism.

19. The method of claim 16, wherein the second steering mechanism comprises a plate steering mechanism.

20. The method of claim 16, wherein the vehicle is a passenger vehicle.
